(19) United States
(12) Patent Application Publication
(10) Pub. No.: US 2011/0104335 A1
(43) Pub. Date: May 5, 2011

(54) PROCESS AND CONFECTIONERY PRODUCT PRODUCED THEREBY

(76) Inventors: Luc Rumbaut, Wieze (BE); Alex Landuyt, Wieze (BE); Maaike Minnaert, Wieze (BE); Dirk De Clercq, Wieze (BE)

(21) Appl. No.: 12/674,930

(22) PCT Filed: Aug. 19, 2008
(86) PCT No.: PCT/EP08/06816

§ 371 Date: Jan. 18, 2011

(30) Foreign Application Priority Data
Aug. 24, 2007 (GB) 0716.6
Oct. 22, 2007 (GB) 0720674.1

(51) Int. Cl. A23G 1/30; A23G 1/32; A23G 1/42; A23G 1/48

(52) U.S. Cl. 426/61; 426/519; 426/631

(57) ABSTRACT

A process for preparing a confectionery product comprising a dispersion of a powder in a matrix comprises: i) providing a liquid matrix material in a container, ii) combining a powder with the liquid matrix material in the container, iii) mixing the powder and the liquid matrix material in the container using a low shear mixer to form a mixture; iv) removing the mixture from the container; and v) optionally, passing the mixture through a filter and/or a magnetic field; wherein the process is operated on a continuous or semi-continuous basis with continuous or semi-continuous supply of liquid matrix material to the container in (i), and the matrix material is selected from chocolate, chocolate-like products and fat continuous confectionery fillings.

This invention relates to a process for producing a confectionery product and to the confectionery product produced by the process.

Many processes are known for producing chocolate and chocolate-like products. Chocolate-like products are materials in which at least a part of the cocoa butter in chocolate is replaced by another fat, such as butterfat, or a vegetable fat such as a cocoa butter equivalent (CBE) or other vegetable fats. Processes for producing chocolate and chocolate-like products typically involve dispersing finely ground ingredients (typically including powders) in a fat phase. The finely ground ingredients may include, for example, cocoa solids, sugar and optionally milk solids. The ingredients that are used are dictated by the nature of the product. Plain chocolate contains cocoa solids but generally does not contain non-fat milk solids, whereas milk chocolate does contain non-fat milk solids and milk fat as additional ingredients. White chocolate is prepared without the addition of cocoa mass or cocoa powder. The fat used to produce the chocolate is typically cocoa butter, optionally at least partly replaced by another fat in chocolate-like products.

Chocolate and chocolate-like products may contain powders.

Probiotics are live bacteria and/or or yeast (typically bacteria), which, when incorporated into the diet, may provide a health benefit. Lactic acid bacteria and bifidobacteria are the most common types of probiotic. Probiotics may assist the body's naturally occurring intestinal flora by inhibiting the growth of harmful or undesirable microbes in the intestine and are sometimes recommended after a course of antibiotics. Probiotics may have other beneficial health properties, such as providing an enhancement of the body's immune system.

Probiotics are generally incorporated into yoghurts or similar food products. However, probiotics have also been incorporated into some other forms of food products. For example, WO 02/065840 discloses the incorporation of fresh probiotics into various food products and into breakfast cereals in particular.

Attempts have been made to incorporate probiotics into confectionery products.

For example, WO 95/22906 describes a food composition comprising a chocolate finger or shell and an optionally fermented dairy filling. The filling contains living lactic acid bacteria.

Chocolate and chocolate-like products sometimes contain added flavours, such as fruit flavours. These flavours can complement the flavour of the chocolate and are often present in compositions that are used as fillings.

U.S. Pat. No. 4,307,126 relates to a method of producing fruit-containing chocolate. The method involves freezing the fruit with an oil or fat, pulverising the frozen mixture and incorporating it into chocolate. The oil or fat is said to prevent agglomeration of the fruit particles.

U.S. Pat. No. 4,837,042 discloses fruit-containing chocolate products and a process for their preparation. The process involves the use of fruit concentrates or pulps.

WO 2007/063563 describes a foodstuff based on cocoa and dehydrated fruit pieces (which do not include fruit powders). There is no disclosure of how the foodstuff can be produced.

WO 2006/007470 relates to food products comprising a food base having a coating of chocolate or cocoa butter encapsulated probiotic. This document asserts that a dried culture of probiotic can be admixed with melted chocolate or cocoa butter to form a homogeneously inoculated melted chocolate. However, no technical details are given about how the process is carried out.

EP-A-704164 describes a composition in which lactic bacteria can be preserved in a living state for a long period.

WO 2006/007463 discloses food products comprising a fat-encapsulated probiotic.

US 2007/0160589 relates to probiotic foods and processes for their preparation.

WO 2006/130698 discloses chocolate products containing amorphous solids, such as corn syrup solids, and methods for their production.

JP 2003018691 relates to a chocolate confectionery based on freeze-dried fruit or beans covered with chocolate.

SU 1200879 describes a chocolate-flavoured sweet confectionery product containing powdered apple.

US 2007/269493 discloses the delivery of active agents using a chocolate vehicle.

JP 2003000147 describes a hard candy containing charcoal powder dispersed in a candy base.

JP 2005333937 discloses a sugar-coated solid food.

U.S. Pat. No. 4,698,232 relates to a soft-textured confectionery composition containing fibre.

We have found that there are considerable difficulties in incorporating powders, such as fruit powders or probiotics, into liquid chocolate and chocolate-like materials on an industrial scale. One of the major difficulties is that the chocolate or chocolate-like material needs to be maintained in a liquid state but, at the same time, the temperature must not be so high that it damages the powder (e.g., by killing the probiotic). Some powders, such as fruit powders, are sensitive to heat and lose their beneficial properties, such as their flavour and/or aroma, at higher temperatures. This requires operation within a relatively narrow temperature range and at a temperature that is lower than that normally used for the processing of liquid confectionery products such as chocolate. However, it is difficult to operate the process in this way and still achieve effective mixing and dispersion of the powder in the product. The powders are difficult to disperse homogeneously and without lumps into an industrial scale batch of liquid chocolate. Also, conventional in-line powder mixing techniques can be detrimental because they usually cause heating of the viscous liquid chocolate or chocolate-like material.

The present invention solves these problems and provides a process that can be operated on a large scale.

According to the present invention, there is provided a process for preparing a confectionery product comprising a dispersion of a powder in a matrix comprising:
i) providing a liquid matrix material in a container;
ii) combining a powder with the liquid matrix material in the container;
iii) mixing the powder and the liquid matrix material in the container using a low shear mixer to form a mixture;
iv) removing the mixture from the container; and
v) optionally, passing the mixture through a filter and/or a magnetic field;
   wherein the process is operated on a continuous or semi-continuous basis with continuous or semi-continuous supply of liquid matrix material to the container in (i).

The invention also provides a process for preparing a confectionery product comprising a dispersion of a powder in a matrix comprising:
i) providing a liquid matrix material, preferably in a container;
ii) combining a powder with the liquid matrix material, preferably in the container;
iii) mixing the powder and the liquid matrix material using a low shear mixer to form a mixture; and
iv) optionally, sieving the mixture and passing it through a magnetic field.

Also provided by the invention is a process for preparing a confectionery product comprising a dispersion of a powder in a matrix, which comprises mixing a powder and a liquid matrix material using a low shear mixer to form a mixture, wherein the process is operated on a continuous or semi-continuous basis with continuous or semi-continuous supply of liquid matrix material to the mixture.

In another aspect, the invention provides a confectionery product produced by the process of the invention. Further provided by the invention in another aspect is a bulk confectionery product comprising a dispersion of a powder in a matrix and having a weight of greater than 100 kg.

Also provided by the invention is a process for preparing a confectionery product comprising a dispersion of a powder in a matrix comprising:
i) providing a liquid matrix material in a container;
ii) combining a powder with the liquid matrix material in the container;
iii) mixing the powder and the liquid matrix material in the container using a mixer to form a mixture, wherein the shear exerted by the mixer is such that the temperature change (in the mixture) during mixing is less than 10° C., preferably less than 5° C., most preferably less than 3° C., such as less than 2° C. or less than 1° C.;
iv) removing the mixture from the container; and
v) optionally, passing the mixture through a filter and/or a magnetic field;
   wherein the process is operated on a continuous or semi-continuous basis with continuous or semi-continuous supply of liquid matrix material to the container in (i).

Further provided by the invention is a process for preparing a confectionery product comprising a dispersion of a powder in a matrix comprising:
i) providing a liquid matrix material in a container;
ii) combining a powder with the liquid matrix material in the container;
iii) mixing the powder and the liquid matrix material in the container using a mixer to form a mixture, wherein the shear exerted by the mixer is such that the particle size preferably changes by less than 25%, more preferably by less than 10% and most preferably there is essentially no change in particle size;
iv) removing the mixture from the container; and
v) optionally, passing the mixture through a filter and/or a magnetic field;
   wherein the process is operated on a continuous or semi-continuous basis with continuous or semi-continuous supply of liquid matrix material to the container in (i).

The invention is particularly, but not exclusively, useful for powders that are sensitive to heat e.g., powders which are deleteriously affected by prolonged exposure to temperatures above about 40° C. The powder is preferably free-flowing. The powder is typically a solid at 25° C. The powder preferably has a particle size in the range of from 0.1 μm to 6 mm. The average particle size of the particles in the powder is preferably in the range of from 0.1 μm to 5 mm, such as from 0.5 μm to 2 mm or from 0.8 μm to 1 mm or from 0.9 μm to 500 μm, more preferably from 1 μm to 300 μm, even more preferably from 5 μm to 100 μm, such as from 10 μm to 50 μm. The powder can be any edible powder that is suitable for incorporation into chocolate, such as fruit powder, honey powder or a probiotic.

The powder is preferably a probiotic or a fruit powder.

The term “fruit powder” as used herein is intended to cover any particulate material having a size of less than about 1 mm that is derived from fruit and retains the flavour and/or aroma of the fruit. Fruit powders are available commercially. Fruit powders are preferably produced by drying, such as spray drying, vacuum drying, drum drying or freeze drying or a combination of these processes. Preferably, drying is carried out at a temperature which is sufficiently low to allow the flavour and/or aroma of the fruit to be retained. Fruit powders typically have a moisture content of below 10% by weight. Fruit powders are preferably produced from the fruit, as a pulp or concentrate, by drying to a water content less than 25% by weight of that of the original fruit.

Some powders of the invention, such as the fruit powders, are preferably not coated (and more preferably not otherwise treated) with another substance prior to use in the invention i.e., it is preferably uncoated. For example, the powder is preferably not coated with an edible fat or oil before it is combined with the liquid matrix material. Other powders, such as probiotics, are preferably coated, for example with fatty acids or glycerides thereof, in order to protect them when they pass through the stomach.

The confectionery product that is produced according to the invention preferably comprises from 0.5% to 15% by weight of the powder, more preferably from 1% to 10% by weight, even more preferably from 2% to 6% by weight.

The process of the invention can be carried out on a large scale for the industrial production of confectionery products containing powders. For example, the product may be produced at a rate of at least 5 tonnes/hour, such as at least 10 tonnes/hour. Typically, the product will be produced at a rate of from 8 to 12 tonnes/hour. As far as the inventors are aware, this is the first time that a process has been described for the production of this type of product on a tonne scale.

The confectionery product can thus be produced on a large scale in bulk form. Preferably, the bulk confectionery product has a weight of at least 120 kg, more preferably at least 500 kg, even more preferably at least 1,000 kg or at least 2,000 kg, such as at least 5,000 kg, or at least 10,000 kg, or at least 15,000 kg, or at least 20,000 kg, e.g., typically up to 30,000 kg or 35,000 kg, such as from 1,000 kg to 35,000 kg or 5,000 kg to 30,000 kg. The bulk confectionery product may be in liquid form. The bulk confectionery product may be stored in a storage tank, or in a tanker for transportation.

The process is preferably operated on a continuous or semi-continuous basis. Typically, this means that the process is carried out for at least part of the overall process operation with simultaneous provision of liquid matrix material and removal of mixture. Thus, the mixer may, for example, be described as operating in-line.

The process preferably has a relatively high throughput of the product. For example, the residence time of the material in the container is preferably less than 5 minutes, more preferably less than 4 minutes, most preferably from 2.5 to 3.5 minutes.

The process of the invention has the advantage that the apparatus that is used to carry out the process can be cleaned and used for making other products (such as chocolate or chocolate-like products containing different additives) relatively easily. It is, of course, important to be able to clean apparatus before it is used for other purposes, particularly when a relatively strongly flavoured additive is to be replaced by an additive having a different flavour or when the apparatus has been in contact with live bacteria (e.g., a probiotic). By operating the process on a continuous or semi-continuous basis, it is possible to use a container having a far smaller volume than would be required for a batch process. This means that the work involved in cleaning the container is far less than would be required for a batch process and smaller amounts of rinsing medium may be used. This is a particular problem associated with the dosing of probiotics in confectionery products that is solved by the present invention.

The process of the invention is applicable to confectionery products having a variety of different matrix materials, provided that they are liquid at a temperature that allows powders (such as live probiotics) to be incorporated into them. The matrix material will typically comprise one or more components selected from sugar, fat and emulsifier (e.g., lecithin). Preferably, the matrix material is selected from chocolate, chocolate-like products or fat continuous confectionery fillings. It is particularly preferred that the matrix material is chocolate or a chocolate-like product. Confectionery products will typically comprise milk or products derived from milk in an amount of less than 70% by weight, preferably less than 60% by weight, more preferably less than 50% by weight, even more preferably less than 40% by weight, and thus do not include products such as milk drinks and yoghurt.

Particularly preferred confectionery products of the invention comprise: a dispersion of a fruit powder in a matrix of chocolate or a chocolate-like product; or a dispersion of a probiotic in a matrix of chocolate or a chocolate-like product.

Chocolate or chocolate-like products preferably comprise one or more components selected from the group consisting of cocoa materials, sugars, sugar substitutes, milk powders, fat, emulsifier, flavouring agents and mixtures thereof. Preferably, the cocoa materials are selected from cocoa powder, cocoa mass, cocoa liquor, cocoa butter and mixtures thereof. Milk powders include, for example, skimmed milk powder, whey powder and derivatives thereof, full cream milk powder and mixtures thereof. Suitable sugars include sucrose, fructose, glucose and dextrose and mixtures thereof (with sucrose being preferred). Sugar substitutes preferably include inulin, dextrin, isomaltulose, polydextrose and maltitol and mixtures thereof. Fats include cocoa butter, butter fat or fractions thereof, palm oil or fractions thereof, coconut or fractions thereof, palm kernel oil or fractions thereof, liquid oils (for example, sunflower oil and/or rapeseed oil and/or soy oil), interesterified mixtures of the above fats or fractions or hardened components thereof, or mixtures thereof. Emulsifiers include lecithin, fractionated lecithin and PGPR or mixtures thereof. Flavouring agents include vanilla and caramel or mixtures thereof. The chocolate may be white chocolate, milk chocolate or dark chocolate. Similarly, chocolate-like products may be white, milk or dark.

The matrix material is provided in the container in a liquid form in part (i) of the process. It will be appreciated that the term “liquid” does not mean fully liquid but rather that the matrix material behaves as a liquid in the process, for example it will flow. Indeed, liquid chocolate contains dispersed solid particles, for example. The liquid matrix material may be manufactured by conventional processes, such as a conventional process for making liquid chocolate which comprises, for example, the steps of refining (to reduce particle size) and conching. The term “container” is also used in broad terms and covers any apparatus having walls that contain the liquid matrix material in at least one direction (so the container may not completely enclose its contents) and allows it to be combined with the powder. The container may, for example, be a length or section of tube or pipe through which the matrix material flows. The container preferably forms part of a mixer. The container is preferably a vessel having a capacity of at least 0.1 m³, more preferably at least 0.15 m³, such as at least 0.2 m³ or at least 0.25 m³. The container preferably has a maximum capacity of 1 m³, more preferably up to 0.8 m³, even more preferably up to 0.7 m³, such as up to 0.6 m³. The container is preferably capable of holding liquid matrix material in an amount of from 100 kg to 1000 kg, more preferably from 125 kg to 800 kg, even more preferably from 150 kg to 700 kg, such as from 200 to 500 kg or from 200 to 300 kg. As explained above, this relatively small size of container facilitates cleaning.

The liquid matrix material is preferably provided to the container from a load tank. The use of a load tank can assist in ensuring that the amount of liquid matrix material matches the amount of powder that is added. The load tank preferably has a capacity of at least 15 tonnes, more preferably at least 22 tonnes, most preferably between 18 and 25 tonnes. The material in the load tank is preferably at a temperature of not more than 60° C., preferably not more than 50° C., most preferably between 35 and 45° C. The residence time of the material in the load tank during continuous operation is preferably less than 3.5 hours, more preferably less than 3.0 hours, most preferably between 1.5 and 2.5 hours.

The temperature of the process is preferably controlled so as to minimise damage to the powder. Preferably, the liquid matrix material in (i) is at a temperature of not more than 60° C., preferably not more than 50° C., most preferably from 35 to 45° C. Liquid chocolate or chocolate-like product may therefore need to be cooled if it is being provided directly from a chocolate making process.

A powder is combined with the liquid matrix material in the container in (ii). Steps (i) and (ii) may be sequential or simultaneous. The powder is preferably added to the liquid matrix material. Liquid matrix material may be added to the container at the same time. Preferably, the powder is added in (ii) using a loss in weight feeder. Suitable apparatus of this type will be known to those skilled in the art. The use of the loss in weight feeder, together with the load tank, allows accurate addition of the powder to the liquid matrix material. Preferably, the powders are dosed at a rate of at least 25 kg/hour, preferably at least 100 kg/hour, most preferably at a rate between 70 and 200 kg/hour. The powders are typically combined with the matrix material at a weight ratio of less than 1:100. Other additives are optionally added to the liquid matrix material and/or the mixture at this stage, either together with the powder or separately e.g., from a separate feeder.

Powders may be single powders or may be mixtures of two or more different powders. Preferred powders are probiotics or fruit powders and mixtures of two or more fruit powders.

Examples of suitable probiotics include yeasts such as Saccharomyces, Debaromyces, Candida, Pichia and Torulopsis, fungi such as Aspergillus, Rhizopus, Mucor, and Penicillium and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Saccharomyces cereviseae, Bacillus coagulans, Bacillus licheniformis, Bacillus subtilis, Bifidobacterium bifidum, Bifidobacterium infantis, Bifidobacterium lactis, Bifidobacterium longum, Enterococcus faecium, Enterococcus faecalis, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus gasseri, Lactobacillus helveticus, Lactobacillus johnsonii, Lactobacillus reuteri, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophilus, Streptococcus faecalis, Streptococcus thermophilus, Staphylococcus carnosus, and Staphylococcus xylosus.

The probiotics may be provided in any suitable form and are preferably in the form of a dried (e.g., lyophilised) powder, optionally encapsulated in a matrix (e.g., comprising one or more of sugar, fat and polysaccharide). Probiotics may be from single species of microorganisms or may be mixtures of two or more different species. Preferred probiotics are selected from the genera Lactobacilli and Bifidobacteria. Particularly preferred probiotics are selected from Bifidobacterium lactis (e.g., HN019), Lactobacillus helveticus (e.g., CNCM I-1722), Bifidobacterium longum (e.g., CNCM I-3470) and mixtures thereof.

Examples of suitable fruit powders include those derived from fruits that are fleshy and sweet, including citrus fruits, such as apple, lemon, pear, cherry, kiwi fruit, plum, apricot, tangerine, raspberry, gooseberry, rhubarb, strawberry, banana, cow berry, passion fruit, blackberry, orange, bilberry, cranberry, elderberry, lime and grape. Preferred fruit powders are powders of strawberry, banana, passion fruit, blackberry, orange, bilberry, cranberry, elderberry, lime and grape skin.

It is particularly preferred that the powder is a fruit powder (such as a powder selected from strawberry, banana, passion fruit, blackberry, orange, bilberry, cranberry, elderberry, lime and grape skin, and mixtures thereof) and the matrix material is white chocolate. The white chocolate typically comprises sugar, cocoa butter, milk or milk powder, and optionally vanilla and/or an emulsifier. Thus, the confectionery product of the invention preferably comprises a matrix of white chocolate comprising sugar, cocoa butter and milk or milk powder (such as skimmed milk powder), together with a fruit powder. The fruit powder is dispersed in the white chocolate, preferably homogeneously. The fruit powder is preferably present in the white chocolate in an amount of from 1% to 20% by weight of the confectionery product, more preferably from 2% to 15% by weight, such as from 3% to 10% by weight. The process of the invention has been found to be particularly useful for the production of this type of product.

In (iii), the powder and the liquid matrix material are mixed in the container using a low shear mixer to form a mixture. This may take place simultaneously with (ii) or sequentially. It was found that control of this step is important because the use of some types of mixer or homogenizer (the terms mixer and homogenizer are synonymous in this context) can cause a detrimental rise in the temperature of the mixture. The mixture of matrix material and powder in (iii) preferably has a temperature of from 30 to 60° C., more preferably from 35 to 45° C. in order to keep the matrix material liquid and yet not adversely affect the powder (e.g., by killing the probiotic). Preferably, the temperature change in (iii) is less than 10° C., preferably less than 5° C., most preferably less than 3° C., such as less than 2° C. or less than 1° C. This can be achieved, even without externally applied cooling, by suitable selection of a low shear mixer. The mixer is preferably a propeller or blade provided in the container, although other techniques for mixing that involve low shear may also be employed. Propeller and blade homogenizers provide relatively gentle yet thorough stirring of the mixture. The mixer speed can be selected to achieve the desired maximum increase in the temperature of the mixture.

If the matrix material comprises solid particles, then during (iii) the particle size preferably changes by less than 25%, more preferably by less than 10% and most preferably there is essentially no change in particle size during (iii).

Preferably, when the powder is a probiotic, during (iii) at least 85% by weight (more preferably at least 90% by weight) of the probiotics remain active. Thus, during (iii) less than 15% by weight of the probiotics are destroyed or damaged, preferably less than 10% by weight. Most preferably, there is no or substantially no destruction or damage of the probiotics during homogenization.

After (iii), the mixture is removed from the container. Typically, the mixture will be pumped out of the container. Liquid matrix material may also be pumped into the container at a rate that balances the rate of removal of the mixture to allow continuous operation of the process.

The mixture is optionally processed after it has left the container. For example, the mixture may be passed through a filter and/or a magnetic field in order to ensure that the mixture contains no contaminants. The filter acts to remove solid contaminants and this step typically involves the passage of the mixture through a sieve which acts as the filter. Preferably, the mixture enters the sieve at a temperature of from 35 to 60° C., more preferably from 40 to 50° C. The sieve typically has a mesh size from 400 μm to 2000 μm, more preferably from 600 μm to 1000 μm, but will have a maximum size greater than the particle size of the powder.

The process of the invention is preferably carried out such that the confectionery product has a homogeneous distribution of powder in the matrix.

Preferably, when the powder is a probiotic, the confectionery product has a level of active probiotics of at least 10⁷/g, preferably at least 10⁸/g most preferably between 10⁹ and 10¹⁰/g. Preferably, the confectionery products have a level of active (i.e, live or viable) probiotics of between 10⁶ and 10¹⁰/g preferably between 10⁷ and 10⁹/g after six months storage at 20° C., and optionally a level of probiotic within this range after twelve months storage at 12° C. to 20° C.

Confectionery products of the invention may comprise prebiotics as optional components in addition to probiotics. Prebiotics are typically food ingredients that beneficially affect the body by selectively stimulating the growth and/or activity of one or more bacteria in the intestine, and thus improve host health. Most potential prebiotics are carbohydrates, but non-carbohydrates may also be used as prebiotics. Thus, prebiotics may be selected from mucopolysaccharides, oligosaccharides, polysaccharides, amino acids, vitamins, nutrient precursors, proteins, and combinations thereof. Preferred prebiotics include oligosaccharides, polysaccharides and mixtures thereof, such as fructooligosaccharides (oligofructose), xylooligosaccharides, galactooligosaccharides, and combinations thereof. Particularly preferred prebiotics are selected from oligofructose, inulin, branched maltodextrins, polydextrose and galactooligosaccharides, and mixtures thereof. Mixtures of oligofructose with inulin are especially preferred.

The product obtained after (v) is typically liquid. The liquid product may be further treated for sale to the consumer or may be sold to industrial customers in liquid form. Prior to consumption, the liquid product is preferably cooled, typically after forming into a desired shape. The product may comprise one or more food additives that are added prior to cooling, such as biscuit, nuts (whole or pieces), crispies, sponge, wafer or fruit, such as cherries, ginger and raisins or other dried fruit. These additives are normally embedded in the product.

The product, when cooled, may take any suitable form and may, for example, be packaged and sold as a block or a bar. Alternatively or additionally, the product of the invention may optionally be filled and may be used as a coating. For example, the product may be used in other confectionery and bakery applications, for example as a cake coating or filling, a biscuit coating or filling, a sponge coating or filling or a coating layer for an ice cream.

Confectionery products of the invention include composite products comprising an outer shell of chocolate or chocolate-like material and a filling, in which either one or both of the outer shell and the filling are produced according to a process of the invention.

The liquid product may optionally have further additives added prior to the final use of the product. For example, the fat content may be increased to from 35% to 50% (such as about 45%) by weight by adding fat to the product prior to use as an ice cream coating.

The product may be used in applications comprising, for example, one or more of moulding, enrobing, dipping, bottoming, filling and panning.

Products of the invention include fat-continuous confectionery fillings. Fillings preferably comprise fat, sugar and optionally one or more of dairy powder (including milk powder and/or yoghurt powder), and flavouring agents. Suitable flavouring agents include, but are not limited to, fruit, nut, and vanilla flavourings, liquid fruit flavours, fruit pieces having larger sizes than the powder (such as from 2 mm to 10 mm), nuts, vanilla, herbs (e.g., mint), herb flavourings, caramel and caramel flavourings. Those skilled in the art are familiar with numerous flavourings than can be used.

The listing or discussion of an apparently prior-published document in this specification should not necessarily be taken as an acknowledgement that the document is part of the state of the art or is common general knowledge. Throughout this specification, all percentages, parts and ratios are by weight unless indicated otherwise

The invention will now be described, by way of non-limiting example only, with reference to the accompanying drawings, in which:

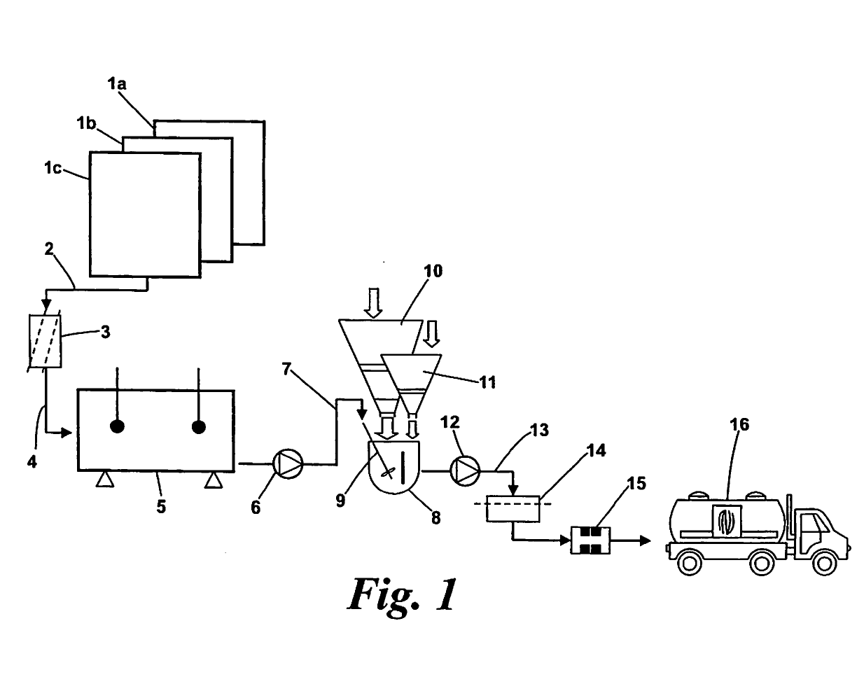

FIG. 1 is a schematic diagram illustrating the process of the invention.

Referring to FIG. 1, chocolate or chocolate-like material is fed from multiple storage tanks 1a, 1b, 1c (although a single storage tank could also be used) via line 2 to heat exchanger 3. The temperature of the chocolate or chocolate-like material is reduced to 45° C. on passage through heat exchanger 3. The cooled chocolate or chocolate-like material then passes through line 4 to load tank 5. Chocolate or chocolate-like product is then dosed by dosing pump 6 via line 7 to container 8. Container 8 is a vessel having a propeller mixer 9.

Powder (such as fruit powder or probiotic) is added to container 8 from loss in weight feeder 10. Addition of the powder from loss in weight feeder 10 is regulated to match the supply of chocolate or chocolate-like material from load tank 5 in order to obtain the correct amount of powder in the product. Optionally, other additives are added to the mixture in container 8 from a second loss in to weight feeder 11. The mixture produced in container 8 is mixed using propeller mixer 9 to form a homogeneous dispersion of the powder in the chocolate or chocolate-like material.

The mixture of powder and chocolate or chocolate-like material is pumped by pump 12 via line 13 firstly through sieve 14 to filter out undesirable large contaminants and then through magnetic field 15 to ensure that the mixture is free from metal contaminants. The liquid mixture may then be filled into tanker 16 for transport to the customer. Alternatively, the mixture may be processed, for example by cooling into bars, optionally after the addition of further additives.

The process shown in FIG. 1 is operated on a continuous or semi-continuous basis with continuous pumping of chocolate or chocolate-like material by pump 6 through line 7 to container 8 and continuous pumping of mixture out of container 8 by pump 12 through line 13. The addition of powder and optional other additives from loss in weight feeders 10 and 11 may also be carried out continuously.

When the process has been completed, the small size of container 8 allows the apparatus to be cleaned with relative ease. Propeller 9 is also easily cleaned. Moreover, the other parts of the apparatus that require cleaning are only those downstream of container 8 and there is no need to clean the larger equipment upstream in the process. Container 8 may comprise a port at its lowest point to allow residual mixture to be removed for even greater ease of cleaning.

### EXAMPLE

A mixture of white chocolate and blueberry powder is produced according to the invention having the following composition:

| Fruit chocolate | | Wt % |
|---|---|---|
| White chocolate | Milk powder | 24.9 |
| | Cocoa butter | 21.2 |
| | Sugar | 48.8 |
| | Others | 0.1 |
| Fruit powder | Blueberry | 5.0 |

| | |
|---|---|
| Total | 100 |

The chocolate is dosed from a weighed load tank by a dosing pump to a container at an average throughput of 1500 kg/h. The container is a Typhoon continuous mixing vessel having a propeller mixer. In this example, the container can contain a total of 60 kg product. The chocolate is continuously fed to the mixing vessel and the flow is measured by the weight difference over time from the load tank.

Blueberry powder is added to the container from a Colortronics Graviblend C-Flex ER loss-in-weight feeder with a single dosing screw at an average throughput of 79 kg/h. Addition of the powder from the loss-in-weight feeder is regulated to match the supply of chocolate from the load tank in order to obtain the correct amount of powder in the product according to the recipe. The mixture produced in the container is mixed using the propeller mixer to form a homogeneous dispersion of the blueberry powder in the white chocolate.

Samples are taken during the trial at the exit of the continuous mixing tank. The homogeneity of the colour of the samples is inspected visually by a panel. All samples are evaluated as being homogeneous.

1. A process for preparing a confectionery product comprising a dispersion of a powder in a matrix comprising: providing a liquid matrix material in a container;
i) combining a powder with the liquid matrix material in the container;
ii) mixing the powder and the liquid matrix material in the container using a low shear mixer to form a mixture, wherein the mixer operates in-line;
iii) removing the mixture from the container; and
iv) optionally, passing the mixture through a filter and/or a magnetic field;
wherein the process is operated on a continuous or semi-continuous basis with continuous or semi-continuous supply of liquid matrix material to the container in (i) and the matrix material is selected from chocolate, chocolate-like products and fat continuous confectionery fillings.

2. A process as claimed in claim 1, wherein the matrix material is chocolate or a chocolate-like product.

3. A process as claimed in claim 1, wherein the product is produced at a rate of at least 5 tonnes/hour.

4. A process as claimed in claim 1, wherein the container has a capacity of from 0.1 to 1 m³.

5. A process as claimed in claim 1, wherein the liquid matrix material in (i) is at a temperature of not more than 60° C.

6. A process as claimed in claim 1, wherein the residence time of the material in the container is less than 5 minutes.

7. A process as claimed in claim 1, wherein the liquid matrix material in (iii) has a temperature of from 30 to 60° C.

8. A process as claimed in claim 1, wherein the liquid matrix material is provided to the container in (i) from a load tank.

9. A process as claimed in claim 8, wherein the load tank has a capacity of at least 15 tonnes.

10. A process as claimed in claim 1, wherein the mixer is a propeller homogenizer.

11. A process as claimed in claim 1, wherein the temperature change during (iii) is less than 10° C.

12. A process as claimed in claim 1, wherein the powder is dosed at a rate of at least 25 kg/hour.

13. A process as claimed in claim 1, wherein the powder is a probiotic.

14. A process as claimed in claim 13, wherein during (iii) at least 85% by weight of the probiotics remain active.

15. A process as claimed in claim 13, wherein the probiotics are selected from Bifidobacterium lactis, Lactobacillus helveticus and Bifidobacterium longum and mixtures thereof.

16. A process as claimed in claim 1, wherein the powder is a fruit powder.

17. A process as claimed in claim 16, wherein the confectionery product comprises from 0.5% to 15% by weight of the fruit powder.

18. A process as claimed in claim 16, wherein the fruit powder is selected from powders of strawberry, banana, passion fruit, blackberry, orange, bilberry, cranberry, elderberry, lime and grape skin, and mixtures thereof.

19. A process as claimed in claim 1, wherein the matrix material is white chocolate.

20. A process as claimed in claim 1, wherein the powder is added in (ii) using a loss in weight feeder.

21. A process as claimed in claim 1, wherein the confectionery product has a homogeneous distribution of the powder in the matrix.

22. A process as claimed in claim 1, wherein the shear exerted by the mixer is such that the temperature increase in the mixture during mixing is less than 10° C.
